(19) United States
(12) Patent Application Publication
(10) Pub. No.: US 2015/0149190 A1
(43) Pub. Date: May 28, 2015

(54) SYSTEMS AND METHODS TO FACILITATE LOCKING MEDICAL EXAMS IN A HEALTHCARE SYSTEM

(71) Applicant: General Electric Company, Schenectady, NY (US)

(72) Inventors: Dianne M. Chace, Charlotte, VT (US); Melaina Anne Oak, South Burlington, VT (US); David John Rumsey, South Burlington, VT (US); Nelson Richard Vargas, Burlington, VT (US); Quentin Charles King, Seattle, WA (US); Jennifer Marie Sorrell, Essex Junction, VT (US); Kimberly Tuure Faris, Williston, VT (US); Maureen A. Scott, Stevensville, MI (US)

(73) Assignee: General Electric Company, Schenectady, NY (US)

(21) Appl. No.: 14/091,561

(22) Filed: Nov. 27, 2013

(51) Int. Cl. G06F 19/00; G06F 3/0484; G06F 3/0481

(52) U.S. Cl. CPC G06F 19/327; G06F 3/04817; G06F 3/04842; G06F 19/322
USPC 705/2

(57) ABSTRACT

Example systems, methods and machine readable storage media to facilitate locking medical exams in a healthcare system are disclosed herein. An example method for locking a medical exam in a workflow queue for a clinical user includes authenticating the clinical user during a user session. The example method also includes obtaining a user selection of the medical exam in the workflow queue during the user session. The example method also includes associating a permission level to a session user identifier associated with the user session. The example method also includes determining whether the permission level includes clearance to lock the medical exam, and, in response to determining that the permission level includes clearance to lock the medical exam, flagging the medical exam as read-only, wherein the flagged medical exam remains flagged after the clinical user ends the user session.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

Healthcare environments, such as hospitals or clinics, include information systems such as hospital information systems (HIS), radiology information systems (RIS), clinical information systems (CIS), cardiovascular information systems (CVIS, etc., and storage systems such as picture archiving and communication systems (PACS), library information systems (LIS), and electronic medical records (EMR). Information stored may include patient medication orders, medical histories, imaging data, test results, diagnosis information, management information, and/or scheduling information, for example. Medical exam results stored in, for example, the radiology information systems, may require review by an examining radiologist.

### BRIEF SUMMARY

Example systems, methods and tangible machine readable storage media to facilitate locking medical exams in a healthcare system are disclosed herein.

An example method to facilitate locking medical exams in a healthcare system disclosed herein includes obtaining a user selection during a user session. The example method also includes associating a permission level to a session user identifier associated with the user session, and determining whether the permission level includes clearance to lock the medical exam. The example method further includes, in response to determining that the permission level includes clearance to lock the medical exam, flagging the medical exam as read-only, wherein the flagged medical exam remains flagged after the clinical user ends the user session.

An example system to facilitate locking medical exams in a healthcare system is also disclosed herein that includes an input handler to obtain a user selection during a user session. The example system also includes a session user handler to associate a session user identifier with the user session, associate a permission level to the session user identifier and to determine whether the permission level includes clearance to lock the medical exam. The example system also includes a flag locker to, in response to determining that the permission level includes clearance to lock the medical exam, flag the medical exam as read-only, wherein the flagged medical exam remains flagged after the clinical user ends the user session.

Also disclosed herein is a machine readable storage medium comprising instructions that, when executed, cause a machine to at least obtain a user selection during a user session, and to associate a session user identifier with the user session. The example instructions also cause the machine to associate a permission level to the session user identifier and to determine whether the permission level includes clearance to lock the medical exam. The example instructions also cause the machine to, in response to determining that the permission level includes clearance to lock the medical exam, flag the medical exam as read-only, wherein the flagged medical exam remains flagged in a persistent database after the clinical user ends the user session.

### BRIEF DESCRIPTION OF SEVERAL VIEWS OF THE DRAWINGS

FIG. 1 illustrates a block diagram of an example exam locking system in an example healthcare system.

FIG. 2 illustrates a block diagram of the example exam locking system of FIG. 1.

FIG. 3 illustrates a first example display of an example graphical user interface associated with the example exam locking system of FIGS. 1 and/or 2.

FIG. 4 illustrates a second example display of an example graphical user interface associated with the example exam locking system of FIGS. 1 and/or 2.

FIG. 5 illustrates a third example display of an example graphical user interface associated with the example exam locking system of FIGS. 1 and/or 2.

FIG. 6 is a flowchart representative of example machine readable instructions that may be executed to initiate use of the example exam locking system of FIGS. 1 and/or 2.

FIGS. 7 and 8 are flowcharts representative of example machine readable instructions that may be executed to modify the lock status of a medical exam at the example exam locking system of FIGS. 1 and/or 2.

FIG. 9 is a block diagram of an example processing platform capable of executing the example machine readable instructions of FIGS. 6-8 to implement the example exam locking system of FIGS. 1 and/or 2.

The foregoing summary, as well as the following detailed description of certain examples of the present invention, will be better understood when read in conjunction with the appended drawings. For the purpose of illustrating the invention, certain examples are shown in the drawings. It should be understood, however, that the present invention is not limited to the arrangements and instrumentality shown in the attached drawings.

### DETAILED DESCRIPTION OF CERTAIN EMBODIMENTS

Although the following discloses example methods, systems and machine readable media including, among other components, software and/or firmware executed on hardware, it should be noted that such methods and apparatus are merely illustrative and should not be considered as limiting. For example, it is contemplated that any or all of these hardware, software, and firmware components could be embodied exclusively in hardware, exclusively in software, or in any combination of hardware and software. Accordingly, while the following describes example methods, systems, and machine readable media, persons of ordinary skill in the art will readily appreciate that the examples provided are not the only way to implement such methods, systems and machine readable media.

The present disclosure relates generally to healthcare applications, and, more particularly, to methods and apparatus to facilitate locking medical exams in a healthcare system.

Many healthcare environments include radiology information systems to facilitate patient examination and/or patient diagnosis. For example, a radiology information system in a healthcare system may store radiology reports, messages, warning, alerts, patient scheduling information, patient demographic data, patient tracking information, and/or physician and patient status monitors. A radiology information system may also enable exam order entering (e.g., ordering an x-ray of a patient) and image and film tracking (e.g., tracking identities of one or more people that have checked a film).

A medical exam may be ordered for a patient, and the medical exam is assigned to a practitioner (e.g., a radiologist) to interpret the exam. For example, a technician may perform the exam (e.g., take x-rays of the patient), and the radiologist may analyze the medical images and clinical symptoms to provide their interpretation of the results of the exam. A practitioner may have a workflow comprising one or more medical exams to be interpreted and an order in which the one or more medical exams are to be interpreted. When a medical exam is assigned and/or allocated to a radiologist, the medical exam is added to a workflow associated with the radiologist. A radiologist workflow includes a listing of medical exams to be interpreted by a radiologist, and an order in which the exams are to be interpreted. The radiologist workflow may indicate what medical exams have been assigned to the radiologist and what medical exams have been allocated to the radiologist. As used herein, an allocation of a medical exam refers to an automatic assignment of a medical exam to a practitioner without user input. As used herein, an assignment of a medical exam refers to a selection of a practitioner to interpret a medical exam.

A medical exam performed on a patient may require review (or analysis) by a healthcare practitioner for purposes of obtaining, for example, diagnostic information from the exam. In a hospital setting, medical exams may be ordered for a plurality of patients, all of which require review by an examining practitioner. Each exam may have associated attributes, such as a modality, a part of the human body under exam, and/or an exam priority level related to a patient criticality level. In some examples, however, not all the information needed for reviewing a medical exam is readily available and/or the examining practitioner may not be able to finish a diagnostic report before tending to another matter. For example, while waiting for a second medical image of a body part for a first patient, a radiologist may need to review medical exams for a second patient who is in critical condition. In known systems, a second radiologist can then begin reviewing the medical exam for the first patient and/or make changes to the work performed by the first radiologist unbeknownst to the first radiologist and while the first radiologist tends to the second patient. For example, not knowing that the second medical image was ordered to supplement the first medical image, the second radiologist can replace the first medical image with the second image, thereby rendering the analysis done by the first radiologist on the first medical image (e.g., adding annotations to the first medical image) meaningless and/or wasted.

Disclosed and described herein are example systems, methods and machine readable media that may be used as part of a radiology information system to enable a practitioner to lock a medical exam, thereby preventing other practitioners from modifying the medical exam and/or information associated with the exam, and allow the practitioner who locked the medical exam to return to the exam to complete his or her analysis of the locked medical exam at a later time. In some examples, a practitioner can lock a medical exam prior to beginning any analysis on the exam. For example, a practitioner can select an exam from his or her workflow based on the patient's name and lock the exam, thereby saving the state of the exam and/or information associated with the exam (e.g., medical images) as it existed when the practitioner locked the exam. Locking a medical exam denies write access to other practitioners, thereby preventing other practitioners from modifying the medical exam and/or information associated with the exam. That is, when an exam is in the locked state, other practitioners may only access the medical exam in read-only mode. For example, when a medical exam is locked, examples disclosed and described herein mark the medical exam and/or information associated with the medical exam stored in the information services with a persistent flag. Thus, unlike some systems in which pausing an exam during a session temporarily saves the exam review while the practitioner remains in the current session, marking the information where it is stored with a persistent flag enables the practitioner to resume reviewing the medical exam across different sessions without concerns that another practitioner modified the exam and/or information associated with the exam. Thus, examples disclosed and described herein allow the practitioner to resume work on a previously locked exam at a different location (e.g., a different workstation, a different healthcare institution, etc.) and/or at a different time (e.g., later in the week, etc.).

The disclosed example systems, methods and machine readable media enable automatically populating the practitioner's workflow with previously locked medical exams. Thus, rather than the practitioner manually querying saved medical exams, all saved medical exams are displayed to the practitioner whenever they access their workflow.

The disclosed example systems, methods and machine readable media include graphical user interfaces accessible by one or more examining radiologists and/or administrators. The graphical user interfaces may be used to lock a medical exam or to unlock a locked medical exam. Further, examples disclosed herein enable associating different permission levels to different practitioners. For example, an examining radiologist may have clearance to lock a medical exam by toggling a button on the user interface, and to unlock medical exams that they themselves locked. In contrast, an administrator may have clearance to unlock medical exams locked by any other practitioner by toggling a second button the user interface. Thus, locked exams may be identified by an icon or button associated with the medical exam. In some examples, the user interface may display a practitioner identifier for the practitioner who locked the exam.

Although the methods, systems and machine readable storage media disclosed here are described in regards to healthcare applications, it is to be understood that the present methods, systems and machine readable storage media can also be used to facilitate locking information in any other industry/application.

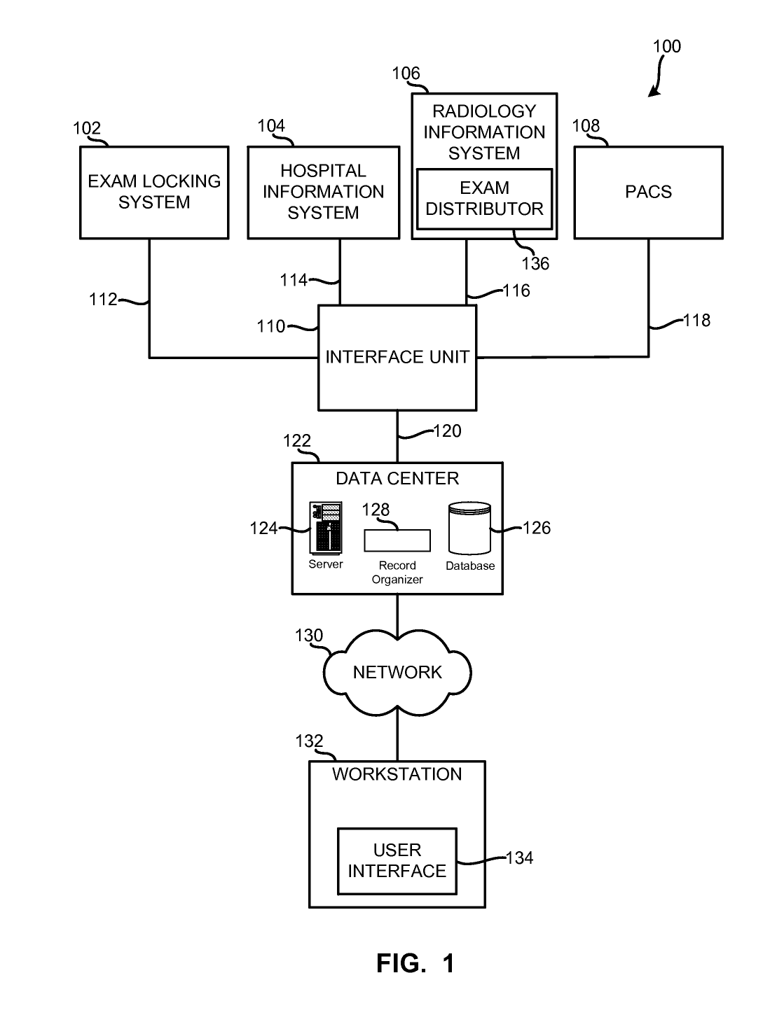

Turning now to the figures, FIG. 1 shows a block diagram of an example healthcare system 100 having an example exam locking system 102, which, in some examples, enables a practitioner such as a technician, a physician, a radiologist, an administrator, etc. to lock a medical exam during a first user session and prevent other healthcare practitioners from writing to the exam and/or information associated with the exam until the practitioner unlocks the exam, for example, during a second user session, as described in further detail below. The healthcare system 100 of the illustrated example includes the exam locking system 102, an example hospital information system (HIS) 104, an example radiology information system (RIS) 106, an example picture archiving and communication system (PACS) 108, an example interface unit 110, an example data center 122, and an example workstation 132. In the illustrated example, the exam locking system 102, the HIS 104, the RIS 106, and the PACS 108 are housed in a healthcare facility and/or locally archived. However, in other examples, the exam locking system 102, the HIS 104, the RIS 106, and/or the PACS 108 can be housed in one or more other suitable locations. In some examples, one or more of the exam locking system 102, the HIS 104, the RIS 106 and/or the PACS 108 can be implemented remotely via a thin client and/or downloadable software solution. Furthermore, one or more components of the healthcare system 100 can be combined and/or implemented together. For example, the exam locking system 102, the RIS 106 and/or the PACS 108 may be integrated with the HIS 104; the PACS 108 may be integrated with the RIS 106; and/or the exam locking system 102 and/or the three example information systems 104, 106, 108 may be integrated together. In other example implementations, the healthcare system 100 includes a subset of the exam locking system 102 and/or the illustrated information systems 104, 106, 108. For example, the healthcare system 100 may include only one or two of the exam locking system 102, the HIS 104, the RIS 106, and/or the PACS 108. Information (e.g., scheduling, test results, observations, diagnosis, etc.) can be entered into the HIS 104, the RIS 106, and/or the PACS 108 by healthcare practitioners (e.g., administrators, radiologists, physicians, and/or technicians) before and/or after patient examination.

The example exam locking system 102 of FIG. 1 enables a radiologist to lock a medical exam, thereby saving the work in progress (e.g., a report in progress, changes to medical images such as annotations, window-leveling, etc.) and preventing other practitioners from modifying the information associated with the medical exam until the medical exam is unlocked. The exam locking system 102 may be connected to any instrument (e.g., equipment, medical device, sensor, etc.) to receive, record, store and/or modify information associated with medical exams. In some examples, the exam locking system 102 includes a user interface and/or a workstation for presenting and/or interacting with the medical exams information. In other examples, the exam locking system 102 may be accessed by the workstation 132, described in detail below. In some examples, the exam locking system 102 is combined and/or implemented with one or more of the other components of the healthcare system 100 (e.g., the exam locking system 102 is combined with the workstation 132). Additionally or alternatively, the exam locking system 102 may receive information associated with medical exams from one or more of the other components of the healthcare system 100 such as, for example, from the information systems 104, 106, 108 that store and maintain patient medical data and reports.

The HIS 104 stores medical information such as clinical reports, patient information, and/or administrative information received from, for example, personnel at a hospital, clinic, and/or a physician's office. The RIS 106 stores information such as, for example, radiology reports, messages, warnings, alerts, patient scheduling information, patient demographic data, patient tracking information, and/or physician and patient status monitors. Additionally, the RIS 106 enables exam order entry (e.g., ordering an x-ray of a patient) and image and film tracking (e.g., tracking identities of one or more people that have checked out a film). In some examples, information in the RIS 106 is formatted according to the HL-7 (Health Level Seven) clinical communication protocol. In the illustrated example of FIG. 1, the RIS 106 includes an example medical exam distributor 136 to facilitate distribution of radiology exams to a radiologist workload for review. In other examples, the exam distributor 136 may be located separately or may be included in any other suitable device of the healthcare system 100.

The PACS 108 stores medical images and data (e.g., x-rays, scans, three-dimensional renderings, digital version of fetal heart monitor strips, etc.) such as, for example, digital images in a database or registry. In some examples, the medical images and data are stored in the PACS 108 using the Digital Imaging and Communications in Medicine (DICOM) format. The medical images and data may be stored in the PACS 108 by healthcare practitioners (e.g., imaging technicians, cardiologists, physicians, radiologists) after a medical imaging of a patient and/or may be automatically transmitted from medical imaging devices to the PACS 108 for storage. In some examples, the PACS 108 also includes a display device and/or a viewing workstation to enable a healthcare practitioner or provider to communicate with the PACS 108. As mentioned above, one or more of the HIS 104, the RIS 106 and/or the PACS 108 may include reports or data including information associated with medical exams, which can be transferred to and/or accessed by the exam locking system 102.

In other examples, additional information systems may be integrated into the healthcare system 100 such as, for example, clinical information systems (CIS), cardiovascular information systems (CVIS), and additional storage systems such as library information systems (LIS) and electronic medical records (EMR), which may also be connected to the example interface unit 110. In some examples, one or more of these information systems include medical exams data that can be transferred to and/or accessed by the exam locking system 102.

In the illustrated example of FIG. 1, the healthcare system 100 includes the example interface unit 110 to facilitate communication among the exam locking system 102, the HIS 104, the RIS 106, the PACS 108, and/or the data center 122. The interface unit 110 of the illustrated example includes an example exam locking system connection 112, an example hospital information system interface connection 114, an example radiology information system interface connection 116, an example PACS interface connection 118, and an example data center interface connection 120. The example interface connections 112, 114, 116, 118, 120 may be implemented by, for example, a Wide Area Network (WAN) such as a private network or the Internet. Accordingly, the example interface unit 110 includes one or more communication components such as, for example, an Ethernet device, an asynchronous transfer mode (ATM) device, an 802.11 device, a digital subscriber line (DSL) modem, a cable modem, a cellular modem, etc. In turn, the example data center 122 communicates with the example workstation 132, via an example network 130, implemented at a plurality of locations (e.g., a hospital, clinic, doctor's office, other medical office, or terminal, etc.). The example network 130 may be implemented by, for example, the Internet, an intranet, a private network, a wired or wireless Local Area Network, and/or a wired or wireless Wide Area Network. In some examples, the interface unit 110 also includes a broker (e.g., a Mitra Imaging's PACS Broker) to allow medical information and medical images to be transmitted together and stored together.

The example interface unit 110 of FIG. 1 receives images, medical reports, administrative information, and/or other clinical information from the exam locking system 102 and/or the information systems 104, 106, 108 and/or the data center 122 via the respective interface connections 112, 114, 116, 118, 120. If necessary (e.g., when different formats of the received information are incompatible), the example interface unit 110 translates or reformats (e.g., into Structured Query Language (SQL) or standard text) the medical information (e.g., patient identification data, medical reports, etc.) to be properly stored at the data center 122. The reformatted medical information may be transmitted using a transmission protocol to enable different medical information to share common identification elements, such as a patient name or social security number. Next, the example interface unit 110 transmits the medical information to the example data center 122 via the data center interface connection 120. Finally, medical information is stored in the example data center 122 in, for example, the DICOM format, which enables medical images and other corresponding medical information to be transmitted and stored together.

In the illustrated example of FIG. 1, the healthcare system 100 includes the example workstation 132 to enable viewing and easily retrieving medical information at a later time via, for example, their common identification element, such as a patient name or record number. The example workstation 132 of FIG. 1 may be any equipment (e.g., a personal computer) capable of executing software that permits electronic data (e.g., medical reports) and/or electronic medical images (e.g., x-rays, ultrasounds, MRI scans, etc.) to be acquired, stored, processed or transmitted for viewing and operation. The example workstation 132 of the illustrated example receives commands and/or other input from a user (e.g., a healthcare practitioner) via, for example, a keyboard, mouse, track ball, microphone, etc. The example workstation 132 is capable of implementing an example user interface 134 (e.g., a graphical user interface) to enable a healthcare practitioner to interact with the healthcare system 100. In some examples, the user interface 134 is an administrator user interface accessible by, for example, a hospital or radiology department administrator. In other examples, the user interface 134 is an examiner user interface accessible by one or more radiologists or technicians.

In the illustrated example of FIG. 1, the example data center 122 is an archive to store medical information such as, for example, images, data, medical reports, and/or, more generally, patient medical records. In addition, the example data center 122 may also serve as a central conduit to information located at other sources such as, for example, data generators, local archives, hospital information systems/radiology information systems (e.g., the HIS 104 and/or the RIS 106), or medical imaging/storage systems (e.g., the PACS 108 and/or connected imaging modalities). That is, the example data center 122 of FIG. 1 can store links or indicators (e.g., identification numbers, patient names, or record numbers) to information. In the illustrated example, the data center 122 is managed by an application server provider (ASP) and is located in a centralized location that can be accessed by a plurality of systems and facilities (e.g., hospitals, clinics, doctor's offices, other medical offices, and/or terminals). In some examples, the data center 122 is spatially distant from the exam locking system 102, the HIS 104, the RIS 106, and/or the PACS 108 (e.g., at General Electric® headquarters).

The example data center 122 of FIG. 1 includes an example server 124, an example database 126, and an example record organizer 128. The example server 124 of FIG. 1 receives, processes, and conveys information to and from the components of the healthcare system 100. The example database 126 of FIG. 1 stores the medical information described herein and provides access thereto. The example record organizer 128 of FIG. 1 manages patient medical histories, for example. The record organizer 128 may also assist in procedure scheduling, for example.

In some examples, the exam locking system 102 is located in the RIS 106. In other examples, the exam locking system 102 may be located separately or may be included in any other component of the healthcare system 100. In some examples, the exam locking system 102 is connected directly to the workstation 132 and the user interface 134. In some examples, the workstation 132 and the user interface 134 are incorporated directly into the exam locking system 102.

The example exam locking system 102 of FIG. 1 enables a radiologist to lock a medical exam during a first user session and prevent other healthcare practitioners from modifying the exam and/or information associated with the exam until the practitioner unlocks the exam. As mentioned above, a radiologist may need additional information or imaging to complete a diagnostic report. Collecting this additional information may take time to gather. The example exam locking system 102 allows the radiologist to save their work in progress and return to the locked exam without worrying about other healthcare practitioners modifying the exam and/or information associated with the medical exam. Furthermore, the exam locking system 102 automatically populates the radiologist's workflow with the locked medical exam(s), thereby eliminating the need for the radiologist to remember which exams were in progress or exam identifying information such as a patient's name, an exam identifier, a record identifier, etc. As a result, the example exam locking system 102 allows a radiologist to efficiently interpret a medical exam with all the necessary information.

Hospital administrators, in managing distribution of medical exams for review by practitioners, may consider exam attributes (e.g., modality, a part of the human body under exam and/or an exam priority level related to a patient criticality level) as well as staff availability, staff credentials, and/or institutional factors such as service level agreements and/or overhead costs. Balancing practitioner workloads in view of the medical exams requiring review may involve time-consuming efforts that result in inefficiencies and/or inequities in exam distribution across a network of practitioners. Further, healthcare practitioners may habitually decline to review and/or select to review medical exams having certain attributes. Load-balancing rules that automatically allocate medical exams to healthcare practitioners while allowing for a user, such as an administrator and/or a practitioner, to review the allocation and control assignment of the medical exams provide for optimization in practitioner workloads in view of hospital workflow goals and clinical targets.

Additionally, a healthcare practitioner may wish to manage his workload, which may include one or more medical exams for review. For example, a healthcare practitioner may wish to designate select times or capacities in which the practitioner is available and/or unavailable to review exams. In some examples, the healthcare practitioner may wish to manage medical exams distributed to his workload based on practitioner specialty and/or exam attributes.

The example medical exam distributor 136 identifies a medical exam needing review and facilitates distribution of the medical exam to a healthcare practitioner, such as a radiologist. The medical exam may be stored in the exam locking system 102, the data center 122 or located in any other component of the healthcare system 100. In some examples, the exam distributor 136 may distribute one or more medical exams to a radiologist using pre-defined load-balancing rules based on one or more characteristics associated with an exam, a radiologist, a network of radiologists, and/or healthcare administrators. For example, as part of the RIS 106, the exam distributor 136 may provide for the creation of one or more radiologist profiles via, for example, the user interface 134. A radiologist profile may define, for example, a radiologist's availability, specialty, preferred exam attributes, and/or other parameters associated with radiologist's workload. The exam distributor 136 may consider the radiologist's profile in distributing radiology exams to the radiologist as well as to other radiologists associated with the RIS 106. For example, a first medical exam may be distributed by the medical exam distributor 136 to a first radiologist based on a specialty profile of the first radiologist, whereas a second medical exam may be distributed to a second radiologist based on the second radiologist's availability in view of a priority level of the exam. Further, one or more of the radiologist profile parameters, such as the radiologist's availability, may be viewable by other radiologists and/or users within the RIS 106 via the user interface 134 at respective workstations 132.

An identifier associated with the medical exam distributed by the example medical exam distributor 136 of FIG. 1 may be viewed by, for example, the radiologist to whom the medical exam has been distributed, other radiologists associated with the RIS 106, and/or a hospital administrator, via a viewer, such as the user interface 134 of the workstation 132. While the exam distributor 136 may automatically distribute the medical exam to a radiologist, the exam distributor 136 may also receive user inputs via the user interface 134 related to confirmation and/or rejection of the automatic allocation of the exam to the radiologist. The medical exam distributor 136 dynamically responds to user inputs related to, for example, allocation of exams, creation/modification of radiologist profiles, and/or other user interaction via the user interface 134 to efficiently distribute medical exams to a reviewing radiologist's workflow in view of exam attributes. The exam distributor 136 further facilitates dynamic sharing of exam distribution statuses and/or radiologist characteristics, such as availability, among users associated with the RIS 106 to provide for a shared workflow management system. In some examples, the exam locking system 102 then allows a radiologist to manage and/or prioritize medical exams once they are added to the radiologist's workflow. For example, the exam locking system 102 enables a radiologist reviewing a first medical exam in the workflow to lock the first medical exam and initiate reviewing a second medical exam in the workflow that associated with a higher exam priority level without concerns of other healthcare practitioners modifying the first medical exam while the radiologist is reviewing the second medical exam.

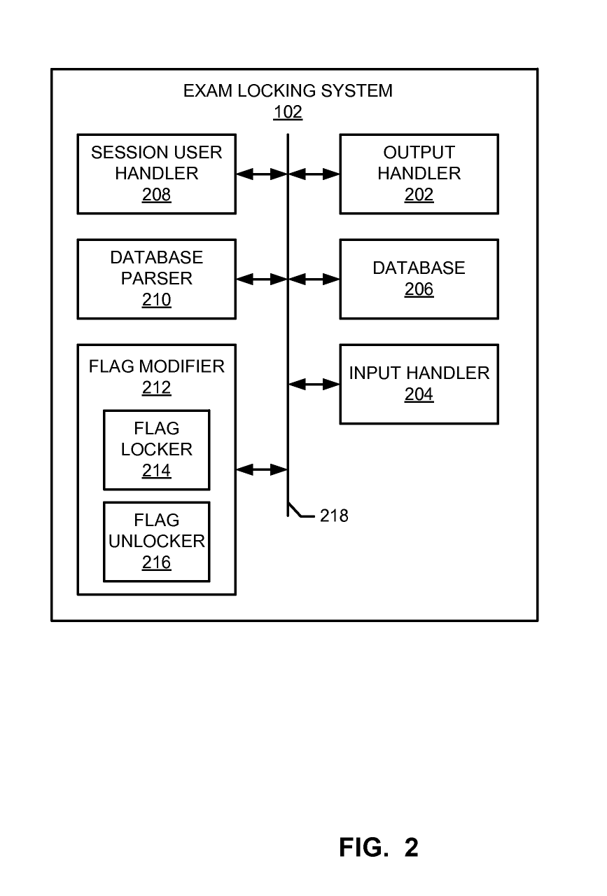

FIG. 2 is a block diagram of an example implementation of the example exam locking system 102 of FIG. 1. In the illustrated example of FIG. 2, the exam locking system 102 enables a radiologist to lock (sometimes referred to herein as “flagging” or “parking”) a medical exam in a healthcare system. When a medical exam is locked, practitioners who did not lock the medical exam are prevented from modifying information associated with the medical exam until the medical exam is unlocked. Furthermore, a medical exam locked by a radiologist remains in the radiologist's workflow until the medical exam is unlocked. As a result, a locked medical exam is persistent through different user sessions, locations, etc., and allows radiologists to manage their workload. For example, a radiologist who is working on a first medical exam may lock the first exam to begin working on a second medical exam with a higher exam priority level (e.g., a medical exam for a patient with a higher criticality level). In other examples, the radiologist may lock the first medical exam at a first healthcare institution and begin interpreting a third medical exam that has more information available than the first medical exam (e.g., a previously ordered medical image becomes available for review). The radiologist may then resume reviewing the first medical exam at a second healthcare institution later that week and without worrying about another healthcare practitioner (e.g., a second radiologist at the first, second or other healthcare institution) modifying the first medical exam between sessions.

The example exam locking system 102 of FIG. 2 includes an example output handler 202, an example input handler 204, an example database 206, an example session user handler 208, an example database parser 210 and an example flag modifier 212. In the illustrated example of FIG. 2, the exam locking system 102 includes the example output handler 202 to interact with the example workstation 132 and/or the example user interface 134 of FIG. 1. The example output handler 202 may communicate with any display device such as a computer screen, an image viewer and/or other display device. The example exam locking system 102 of FIG. 2 includes the example input handler 204 to obtain user input from one or more of the example workstations 132 and/or the example user interfaces 134. In some examples, the input handler 204 obtains data directly from the example information systems 104, 106, 108 and/or the example data center 122 of FIG. 1.

In the illustrated example of FIG. 2, the exam locking system 102 includes the example database 206 to store exam information including patient and physician information as well as information associated with the exam locking system 102. For example, the database 206 may store login information for registered healthcare practitioners and permission levels associated with the healthcare practitioners. In some examples, the database 206 stores information associated with exams and radiologists at a healthcare institution such as a hospital. In some examples, the database 206 receives and stores exam and radiologist information for more than one healthcare institution. For example, several institutions (e.g., hospitals, outpatient facilities, etc.) may affiliate with respect to exam review such that a patient is examined at a first institution and a radiologist at a second institution is assigned to review the exam. In some such examples, the database 206 stores identifying information associated with the institution where the exam was performed to assist in cross-enterprise review of exams.

In the illustrated example of FIG. 2, the example exam locking system 102 includes the example session user handler 208 to manage practitioner access to medical exams. For example, a healthcare practitioner (e.g., a technician, a physician, a radiologist, an administrator, etc.) may attempt to initiate a user session via the example workstation 132 and/or the example user interface 134. In some such examples, the session user handler 208 authenticates the practitioner via login information stored in the example database 206. The example session user handler 208 may then control the information available to the healthcare practitioner. For example, the session user handler 208 may only display medical exams assigned and/or allocated to the session user and block the session user from seeing medical exams that assigned and/or allocated to another healthcare practitioner.

In some examples, the session user handler 208 of FIG. 2 associates permission levels with a healthcare practitioner when the practitioner is an authenticated user. As used herein, permission levels (sometimes referred to herein as “security levels” or “clearance levels”) define permitted user actions for different healthcare practitioners. For example, a permission level associated with a first practitioner (e.g., a technician or a physician) may permit the first practitioner to enter an exam order (e.g., order an x-ray of a patient), track images and/or films (e.g., track identifies of one or more people who have checked a film), view locked and/or unlocked medical exams, etc. A permission level associated with a second practitioner (e.g., a radiologist) may permit the second practitioner to also lock a medical exam and to unlock medical exams that were previously locked by the practitioner, while a permission level associated with a third practitioner (e.g., a radiology department administrator) may permit the third practitioner to also unlock medical exams that were previously locked by other practitioners.

In the illustrated example, the session user handler 208 of FIG. 2 obtains the associated permission levels from the example database 206. For example, the permission levels may be stored in the database 206 as a data structure such as a table (e.g., a lookup table), a list, a document, etc. In some examples, the permission levels may be assigned based on the different practitioner types (e.g., a technician, a physician, a radiologist, an administrator, etc.) and/or on experience level of the different practitioners (e.g., a seventh-year radiologist may be permitted to unlock medical exams that were locked by a first-year radiologist).

In the illustrated example of FIG. 2, the exam locking system 102 includes the example database parser 210 to generate workflow queues to display to a session user (e.g., a clinical user) via, for example, the output handler 202. For example, the database parser 210 may parse the database 206 and/or the example data center 122 (FIG. 1) to identify assigned and/or allocated medical exams. In some examples, the database parser 210 filters the identified medical exams based on the session user permission levels. For example, the database parser 210 may filter the identified medical exams to cause the output handler 202 to display only medical exams associated with (e.g., assigned and/or allocated to) the session user.

In some examples, the database parser 210 filters the identified medical exams based on user selections. For example, the database parser 210 may receive instructions via the example input handler 204 from the session user and filter the medical exams accordingly. For example, an administrator may desire to see only the medical exams associated with a specific radiologist. In some such examples, the input handler 204 receives a practitioner identifier for the radiologist (e.g., a session user identifier, a name and/or an alphanumeric code selected from a menu, entered into a search field, etc.) and communicates the practitioner identifier to the database parser 210. The example database parser 210 then parses the database 206 and/or the example data center 122 to identify medical exams associated with the practitioner identifier.

In some examples, the database parser 210 filters the identified medical exams based on the status of a lock flag associated with the medical exams. For example, the database parser 210 may cause the output handler 202 to display locked medical exams while not displaying unlocked medical exams. In some examples, the database parser 210 facilitates displaying all medical exams locked by the session user regardless of received user selections. For examples, a radiologist may instruct the exam locking system 102 to display all medical exams to be reviewed by the radiologist on a particular day or at a certain healthcare institution. In some such examples, the database parser 210 may parse the database 206 to identify all medical exams associated with the radiologist and that are marked to be reviewed by the radiologist on the selected date or at the selected healthcare institution, as well as all medical exams that were previously locked by the radiologist (e.g., at an earlier time or at a different healthcare institution).

In the illustrated example of FIG. 2, the exam locking system 102 includes the example flag modifier 212 to update a lock flag associated with each of the medical exams stored in the example database 206 and/or the example data center 122 in response to received user actions. The lock flag of a medical exam indicates whether the medical exam is in the locked state or the unlocked state (e.g., the lock status). In some examples, the flag modifier 212 determines whether updating the lock flag of a medical exam based on the user action is permitted. For example, when a healthcare practitioner attempts to lock a medical exam, the flag modifier 212 may check whether the practitioner has the requisite permission level to lock the medical exam. In some such examples, the flag modifier 212 may receive a notification from the example session user handler 208 indicative of whether the healthcare practitioner has the requisite clearance to execute the action.

As discussed above, when the lock flag of a medical exam is in the locked state, the exam locking system 102 prevents healthcare practitioner who did not lock the medical exam from modifying (e.g., writing to) the medical exam. That is, a locked medical exam is reserved for the radiologist who locked the medical exam. In some examples, other healthcare practitioners may access (e.g., view) a locked medical exam, but may not modify information associated with the medical exam. That is, a locked medical exam is read-only to those healthcare practitioner who did not lock the medical exam. As a result, a radiologist reviewing a medical exam may save their progress (e.g., a report in progress, changes to medical images such as including annotations, window-leveling, etc.) and return to the locked medical exam at a later time without worrying about other healthcare practitioners changing information associated with the medical exam. In contrast, while the lock flag of a medical exam is in the unlocked state (e.g., an unlocked medical exam), the exam locking system 102 allows any healthcare practitioner with the requisite clearance to lock the medical exam and/or modify information associated with the medical exam, even if the medical exam was previously locked and then unlocked by another practitioner. For example, a technician may update a medical image included in a medical exam. Thus, it may be beneficial to make sure locking or unlocking a medical exam is a permitted user action.

To this end, the example flag modifier 212 of FIG. 2 includes an example flag locker 214 to determine whether to toggle the lock flag of a medical exam from an unlocked state to a locked state (sometimes referred to herein as “setting the lock flag”), and an example flag unlocker 216 to determine whether to toggle the lock flag of a medical exam from a locked state to an unlocked state (sometimes referred to herein as “resetting the lock flag”). The example flag locker 214 of FIG. 2 receives instructions to lock a medical exam (e.g., via the example input handler 204) and determines whether the session user has the requisite clearance before locking the medical exam. For example, the flag locker 214 may compare the session user identifier with the permission level associated with the session user identifier. The example flag locker 214 may then lock the medical exam if the session user has clearance to lock medical exams. In some examples, when the flag locker 214 locks the medical exam, the flag locker 214 sets the lock flag associated with the medical exam (e.g., toggles the lock flag to a 1, true, on, yes, etc.) in the database 206. Once the example flag locker 214 locks the medical exam, the information associated with the medical exam is marked as read-only, thereby preventing the healthcare practitioners from modifying the information. In some examples, the read-only status only applies to other healthcare practitioners. That is, the radiologist who locked the medical may continue to modify the medical exam while the medical exam is in the locked state. In some examples, the flag locker 214 appends a radiologist identifier (e.g., the session user identifier) to the medical exam to identify the radiologist who locked the medical exam. In some examples, when the flag locker 214 determines the session user does not have clearance to lock the medical exam, the flag locker 214 may output, via the example output handler 202, an alert to indicate the session user does not have the proper clearance. For example, the flag locker 214 may cause the output handler 202 to output a sound, flash the user interface 134, display text (e.g., “You are not authorized to lock the medical exam”) in the user interface 134, etc.

In contrast, when the example flag modifier 212 of FIG. 2 receives instructions to unlock a medical exam (e.g., via the example input handler 204), the example flag unlocker 216 determines whether the session user is permitted to unlock the medical exam before unlocking the medical exam. For example, the flag unlocker 216 may check whether the session user identifier matches the radiologist identifier who locked the medical exam and unlock the medical exam when a match exists. In some examples, the flag unlocker 216 compares the permission level associated with the session user and unlock the medical exam when the session user has the requisite clearance. For example, a radiology department administrator may have the requisite clearance to unlock a locked medical exam if, for example, the radiologist who locked the medical exam is unavailable (e.g., on vacation) to resume reviewing the medical exam. In some examples, when the flag unlocker 216 unlocks a locked medical exam, the flag unlocker 216 resets the lock flag associated with the medical exam (e.g., toggles the lock flag to a 0, false, off, no, etc.) in the database 206. When the example flag unlocker 216 unlocks the medical exam, the information associated with the medical exam is unmarked as read-only, thereby allowing other healthcare practitioners to modify the information and/or lock the medical exam. In some examples, the flag unlocker 216 may also clear the radiologist identifier appended to the medical exam when unlocking the medical exam. In contrast, when the example flag unlocker 216 determines the session user does not have clearance to unlock the locked medical exam, the flag unlocker 216 may output, via the example output handler 202, an alert to indicate the session user does not have the proper clearance. For example, the flag unlocker 216 may cause the output handler 202 to output a sound, flash the user interface 134, display text (e.g., “You are not authorized to unlock the locked medical exam.”) in the user interface 134, etc.

In the illustrated example of FIG. 2, the output handler 202, the input handler 204, the database 206, the session user handler 208, the database parser 210, the flag modifier 212, the flag locker 214 and the flag unlocker 216 are in communication with each other via an example data bus 218. However, in other examples, the output handler 202, the input handler 204, the database 206, the session user handler 208, the database parser 210, the flag modifier 212, the flag locker 214 and/or the flag unlocker 216 may be located offsite or implemented in another device such as, for example, one or more of the components of the healthcare system 100 shown and described in FIG. 1.

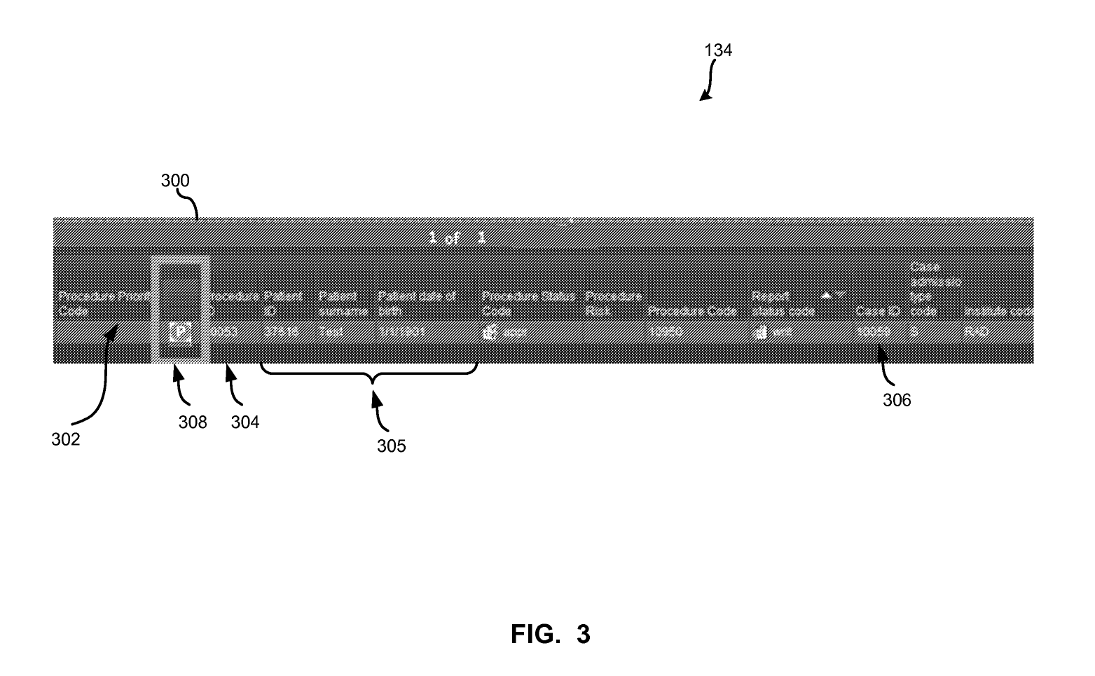

FIGS. 3-5 illustrate example user interfaces 134 for interacting with the example exam locking system 102 of FIGS. 1 and/or 2. The example user interface 134 may include, for example, an administrator user interface, an examiner user interface, etc. The example user interface 134 may include one or more displays (or screens) for interacting with the example exam locking system 102, as will be discussed herein in connection with FIGS. 3-5.

FIG. 3 illustrates an example first display 300 of the example user interface 134. The example first display 300 (e.g., a graphical user interface, a presentation display, etc.) displays information in association with locking or unlocking medical exams via the exam locking system 102 of FIGS. 1 and/or 2. In some examples, the first display 300 may display, for example, information concerning a radiologist's workload based on medical exams assigned and/or allocated to the radiologist (e.g., a workflow queue). In some examples, the first display 300 may serve as a workflow notification page for a radiologist by listing medical exams that the radiologist has been assigned to review, for example, on a certain day or in a certain order.

The example first display 300 includes an example exam identifier 302. In some examples, the exam identifier 302 is a visual representation of one or more medical exams requiring review by a radiologist. The exam identifier 302 may include, for example, an exam procedure identifier 304 (“0053”), patient identifying information 305 (e.g., a patient identifier (“37616”), a name of the patient on which the exam was performed (“Test”), a date of birth of the patient (“1/1/1901”), etc.), and an example case identifier 306 (“10059”). The exam identifier 302 may also include other customizable information regarding the medical exam.

The example first display 300 of the example user interface 134 also displays a lock flag identifier 308. The example lock flag identifier 308 is a visual representation of the lock status (e.g., locked state or unlocked state) of the medical exam based on implementation of the example exam locking system 102. Further, the lock flag identifier 308 may dynamically update in response to communicative interactions with the exam locking system 102 via, for example, the user interface 134. In the illustrated example, the lock flag identifier 308 (e.g., the letter “P” inside a circle) indicates that the medical exam is in the locked state. In contrast, a lock flag identifier that is the letter “P” inside a square indicates that the medical exam is in the unlocked state.

Any of the exam identifier 302, the exam procedure identifier 304, the patient identifying information 305, the case identifier 306 and/or the lock flag identifier 308 may be dynamically updated based on, for example, implementation of the exam locking system 102 and/or user interaction with the user interface 134. Further, any of the identifiers 302, 304, 305, 306, 308 may be represented on the first display 300, or any other screens of the user interface 134, by a variety of means of visual display including, for example, being flagged/unflagged, highlighted/un-highlighted, displayed/hidden and/or activated/deactivated. The identifiers 302, 304, 305, 306, 308 displaying in the example first display 300 may also be selectively tailored based on, for example, whether the example first display 300 displays information for a radiology department at a hospital or across a network of healthcare institutions.

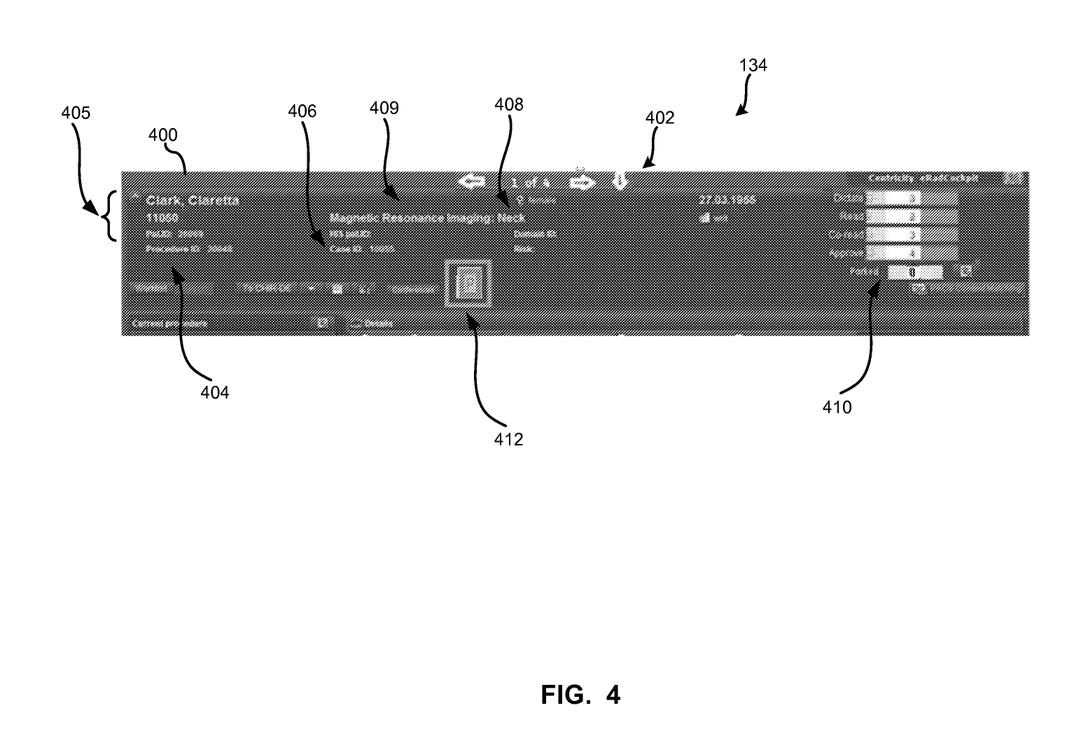

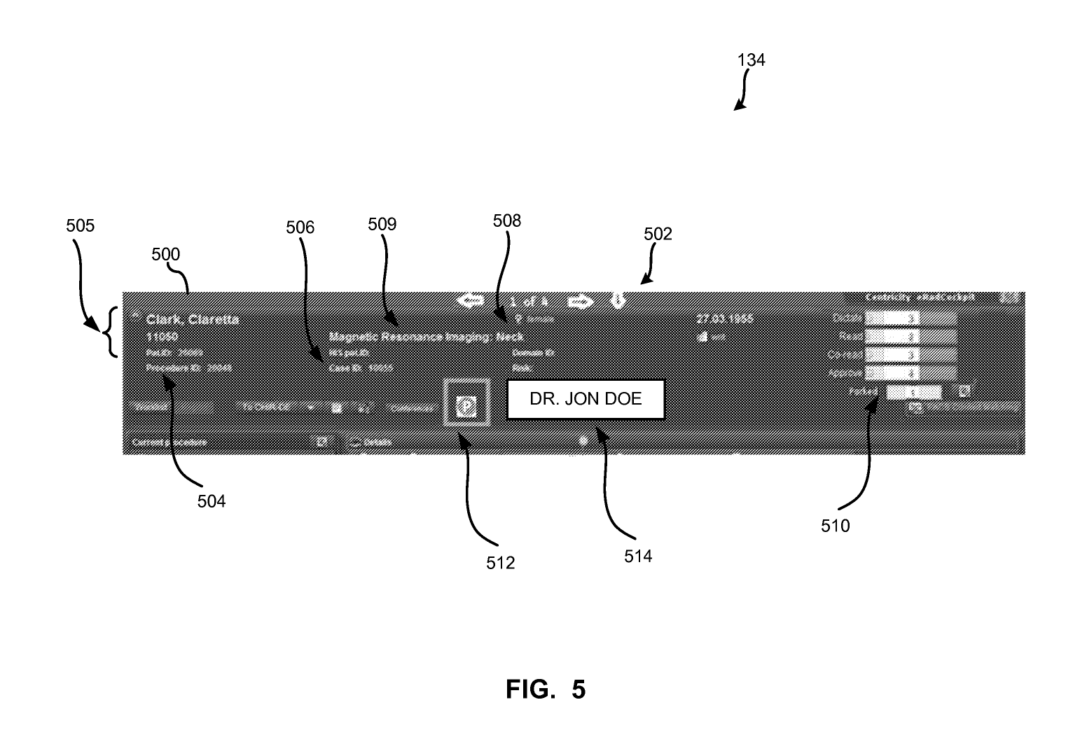

A healthcare practitioner interacting with the first display 300 may select to view additional information about a medical exam listed in the first display 300. Upon selecting a medical exam (e.g., via the example medical identifier 302), another screen (e.g., an example second display 400 (FIG. 4) or an example third display 500 (FIG. 5)) may display, for example, additional information about the selected medical exam such as medical images and/or data.

In operation, for example, the example first display 300 of the user interface 134 provides a healthcare practitioner, such as one or more radiologists in a network, with an overview of one or more medical exams requiring review and associated medical exam information. Additionally, the example first display 300 allows a healthcare practitioner to selectively view additional information about a medical exam. Thus the example first display 300 may serve as a dashboard for an overview of the workflow queue of a healthcare practitioner and/or a launch pad for further review of a medical exam.

FIG. 4 illustrates an example second display 400 of the example user interface 134 for interacting with the example exam locking system 102 of FIGS. 1 and/or 2. The example second display 400 displays additional information about a selected medical exam 402. For example, the second display 400 may include medical images such as x-rays, magnetic resonance imaging scans, computed tomography scans, etc. associated with the example medical exam 402.

In some examples, a healthcare practitioner may view the example second display 400 by selecting an exam identifier 302 associated with an unlocked medical exam from the example first display 300 (FIG. 3). In other examples, a healthcare practitioner may reach the example second display 400 via links provided on one or more other displays of the example user interface 134, or directly upon accessing the user interface 134.

The example medical exam 402 displaying in the example second display 400 includes an example exam procedure identifier 404 and example patient identifying information 405 (e.g., a name of a patient on which the exam was performed (“Clark, Ciaretta”), a patient identifier (“26069”), the gender of the patient (“female”), etc.) and an example case identifier 406 (“10055”). The example medical exam 402 also includes an example body part identifier 408 on which the medical exam was performed (“neck”) and an example exam modality identifier 409 (“magnetic resonance imaging”). The example second display 400 also includes an example lock status identifier 410 and an example lock flag control 412. The lock status identifier 410 is a visual representation of the lock status (e.g., locked state or unlocked state) of the example medical exam 402 displayed in the example second display 400. In the illustrated example, the lock status identifier 410 (“0”) indicates that the medical exam 402 is in the unlocked state (e.g., is an unlocked medical exam). Accordingly, any healthcare practitioner with clearance to review a medical exam may review the medical exam 402 (e.g., prepare a report, make changes to medical images included in the medical exam (e.g., including annotations, window-leveling, etc.)).

In the illustrated example, the example lock flag control 412 allows a user to modify (e.g., change, toggle, etc.) the lock status of a medical exam. For example, the lock flag control 412 may be a selectable button that a healthcare practitioner may select via the example second display 400. In the illustrated example, the visual representation of the lock flag control 412 corresponds to the lock status identifier 410. That is, when the lock status identifier 410 indicates that the medical exam 402 is unlocked (e.g., is “0”), the visual representation of the lock flag control 412 also indicates that the medical exam 402 is in the unlocked state (e.g., represented by the letter “P” inside a square in the illustrated example).

A healthcare practitioner interacting with the example second display 400 may select the lock flag control 412 to toggle the lock status of the medical exam 402 displaying in the second display 400. Upon selecting the lock flag control 412, another screen (e.g., an example third display 500 (FIG. 5)) may display, for example, dynamically updated information. The example exam locking system 102 of FIGS. 1 and/or 2 updates and/or synchronizes information about the selected medical exam in the second display 400 in response to the healthcare practitioner accessing the lock flag control 412.

FIG. 5 illustrates an example third display 500 of the example user interface 134 for interaction with the example exam locking system 102 of FIGS. 1 and/or 2. In the illustrated example, the third display 500 displays additional information about a selected medical exam 502 similar to the second display 400.

In some examples, a healthcare practitioner may view the example third display 500 by selecting an exam identifier 302 associated with an unlocked medical exam from the example first display 300 (FIG. 3). In other examples, a healthcare practitioner may reach the example third display 500 via links provided on one or more other displays of the example user interface 134 (e.g., by selecting the lock flag control 412 of the second display 400), or directly upon accessing the user interface 134.

The example medical exam 502 displaying in the third display 500 includes an example exam procedure identifier 504 and example patient identifying information 505 (e.g., a name of a patient on which the exam was performed (“Clark, Ciaretta”), a patient identifier (“26069”), the gender of the patient (“female”), etc.) and an example case identifier 506 (“10055”). The example medical exam 502 also includes a body part identifier 508 on which the medical exam was performed (“neck”) and an example exam modality identifier 509 (“magnetic resonance imaging”). The example third display 500 also includes an example lock status identifier 510 and an example lock flag control 512. The lock status identifier 510 is a visual representation of the lock status (e.g., locked state or unlocked state) of the example medical exam 502 displayed in the example third display 500. In the illustrated example, the lock status identifier 510 (“1”) indicates that the medical exam 502 is in the locked state. Accordingly, while other healthcare practitioners may access the medical exam 502, only the radiologist who locked the medical exam may continue reviewing the medical exam 502 (e.g., resuming a report in progress, making changes to medical images included in the medical exam (e.g., including annotations, window-leveling, etc.)). Further, the locked medical exam 502 may be unlocked only by the radiologist who locked the medical exam and/or another healthcare practitioner who has the requisite clearance to unlock the medical exam (e.g., a radiology department administrator).

In the illustrated example, the example lock flag control 512 allows a healthcare practitioner to modify (e.g., change, toggle, etc.) the lock status of a medical exam. For example, the lock flag control 512 may be a selectable button that a healthcare practitioner may select via the example third display 500. In the illustrated example, the visual representation of the lock flag control 512 corresponds to the lock status identifier 510. That is, when the lock status identifier 510 indicates that the medical exam is locked (e.g., is “1”), the visual representation of the lock flag control 512 also indicates that the medical exam 502 is in the locked state (e.g., represented by the letter “P” inside a circle in the illustrated example). Further, in the illustrated example of FIG. 5, when a healthcare practitioner hovers (e.g., overlays) a mouse over the lock flag control 512, an example pop-up frame 514 displays the radiologist identifier for the radiologist who locked the exam (“Dr. Jon Doe”). In some examples, the third display 500 may display the radiologist identifier whenever the medical exam is in the locked state.

A healthcare practitioner interacting with the example third display 500 may select the lock flag control 512 to toggle the lock status of the medical exam 502 displaying in the third display 500. Upon selecting the lock flag control 512, another screen (e.g., the example second display 400 (FIG. 4)) may display, for example, dynamically updated information. The example exam locking system 102 of FIGS. 1 and/or 2 updates and/or synchronizes information about the selected medical exam in the third display 500 in response to the healthcare practitioner accessing the lock flag control 512.

In operation, for example, the example second display 400 and the example third display 500 of the user interface 134 provides a practitioner, such as one or more radiologists in a network, with detailed (e.g., additional) information about a medical exam that was not displayed via the example first display 300. Additionally, the second display 400 and the third display 500 allow a healthcare practitioner to lock or unlock a selected medical exam, respectively. For example, when the lock flag control 412 is selected in the second display 400, the example exam locking system 102 determines whether the session user is permitted to lock the medical exam (e.g., whether the healthcare practitioner has the requisite clearance to lock the medical exam). In response to determining that the session user is permitted to lock the medical exam, the healthcare practitioner is presented with the third display 500, which displays the detailed information about the medical exam that was displayed by the second display 400, but also updates the status of the lock status identifier 410 and the lock flag control 412, accordingly. Otherwise, the example exam locking system 102 provides an alert to the session user that the session user is unauthorized to lock the medical exam (e.g., the practitioner does not have the requisite clearance to lock the medical exam).

In contrast, when the lock flag control 512 is selected in the third display 500, the example exam locking system 102 determines whether the session user matches the radiologist who locked the medical exam and/or whether the session user is permitted to unlock the medical exam. In response to determining that the session user matches the locking radiologist and/or that the session user is permitted to unlock the medical exam (e.g., the healthcare practitioner has the requisite clearance to unlock the medical exam), the healthcare practitioner is presented with the second display 400, which displays the detailed information about the medical exam, but also updates the status of the lock status identifier 510 and the lock flag control 512, accordingly. Otherwise, the example exam locking system 102 provides an alert to the session user that the session user is unauthorized to unlock the medical exam (e.g., the healthcare practitioner does not have the requisite clearance to unlock the medical exam).

While an example manner of implementing the exam locking system 102 of FIG. 1 is illustrated in FIG. 2, one or more of the elements, processes and/or devices illustrated in FIG. 2 may be combined, divided, re-arranged, omitted, eliminated and/or implemented in any other way. Further, the example output handler 202, the example input handler 204, the example database 206, the example session user handler 208, the example database parser 210, the example flag modifier 212, the example flag locker 214, the example flag unlocker 216 and/or, more generally, the example exam locking system 102 of FIG. 1 may be implemented by hardware, software, firmware and/or any combination of hardware, software and/or firmware. Thus, for example, any of the example output handler 202, the example input handler 204, the example database 206, the example session user handler 208, the example database parser 210, the example flag modifier 212, the example flag locker 214, the example flag unlocker 216 and/or, more generally, the example exam locking system 102 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example output handler 202, the example input handler 204, the example database 206, the example session user handler 208, the example database parser 210, the example flag modifier 212, the example flag locker 214 and/or the example flag unlocker 216 is/are hereby expressly defined to include a tangible computer readable storage device or storage disk such as a memory, a digital versatile disk (DVD), a compact disk (CD), a Blu-ray disk, etc. storing the software and/or firmware. Further still, the example exam locking system 102 of FIG. 1 may include one or more elements, processes and/or devices in addition to, or instead of, those illustrated in FIG. 2, and/or may include more than one of any or all of the illustrated elements, processes and devices.

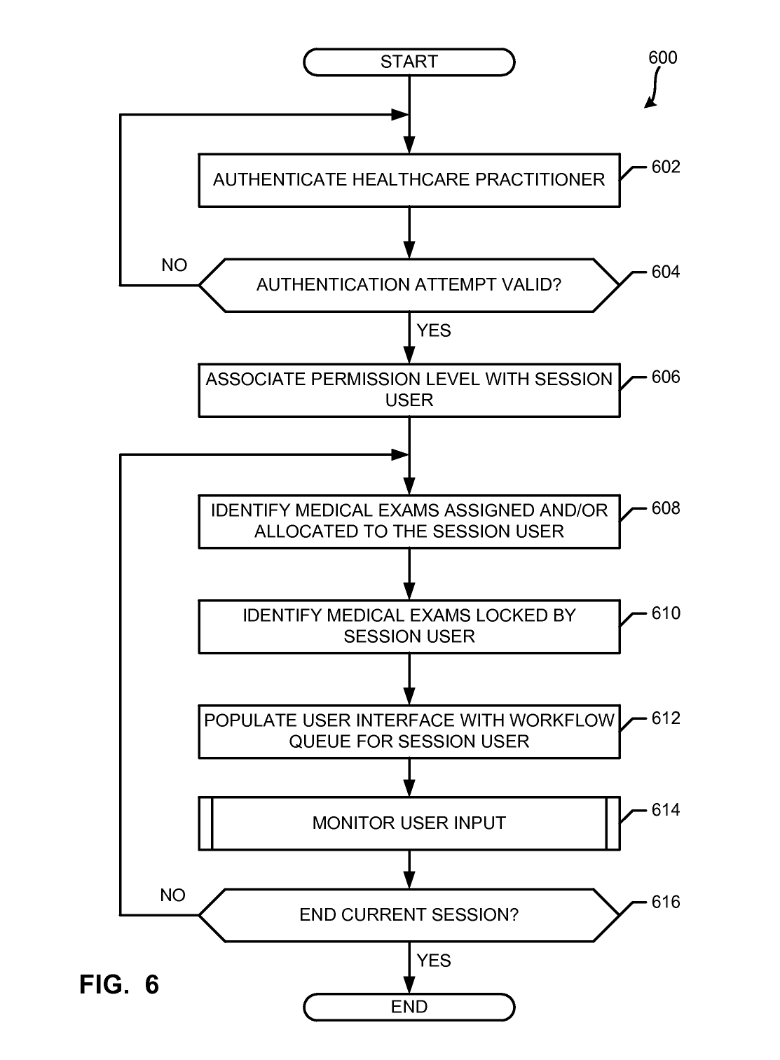

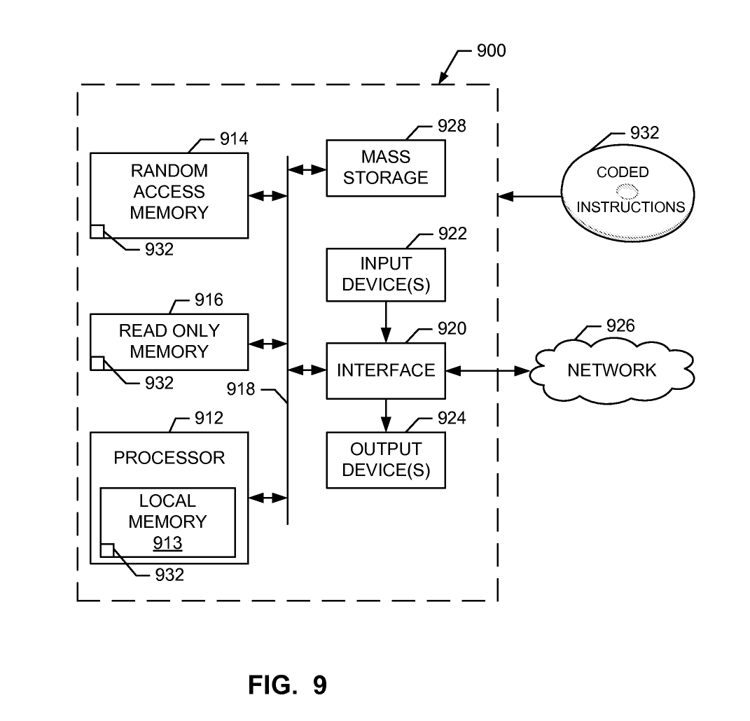

Flowcharts representative of example machine readable instructions for implementing the exam locking system 102 of FIGS. 1 and/or 2, and/or the displays of FIGS. 3-5 are shown in FIGS. 6-8. In these examples, the machine readable instructions comprise a program for execution by a processor such as the processor 912 shown in the example processor platform 900 discussed below in connection with FIG. 9. The program may be embodied in software stored on a tangible computer readable storage medium such as a CD-ROM, a floppy disk, a hard drive, a digital versatile disk (DVD), a Blu-ray disk, or a memory associated with the processor 912, but the entire program and/or parts thereof could alternatively be executed by a device other than the processor 912 and/or embodied in firmware or dedicated hardware. Further, although the example program is described with reference to the flowcharts illustrated in FIGS. 6-8, many other methods of implementing the example exam locking system 102 and/or the example displays of FIGS. 3-5 may alternatively be used. For example, the order of execution of the blocks may be changed, and/or some of the blocks described may be changed, eliminated, or combined.

As mentioned above, the example processes of FIGS. 6-8 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 6-8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The example program of FIG. 6 initiates the example exam locking system 102 (FIGS. 1 and/or 2) in the example healthcare system 100 (FIG. 1). The example program of FIG. 6 begins at block 602 when the exam locking system 102 authenticates a healthcare practitioner. For example, a healthcare practitioner may attempt to initiate a user session via the example user interface 134 (FIGS. 1, 3, 4 and/or 5) of the example workstation 132 (FIG. 1). In some such examples, the example session user handler 208 (FIG. 2) compares the credentials of the healthcare practitioner received via the example input handler 204 (FIG. 2) (e.g., a user name such as a practitioner identifier and a password) against login information stored in the example database 206 (FIG. 2). If, at block 604, the example session user handler 208 determines that the authentication failed (e.g., the healthcare practitioner credentials do not match login information stored in the example database 206), then control returns to block 602 to re-authenticate the healthcare practitioner. In some examples, after a preset number of failed attempts, the example session user handler 208 may block the healthcare practitioner from accessing the workstation 132.

Otherwise, if the example session user handler 208 determines that the authentication is valid (e.g., the healthcare practitioner credentials to match login information stored in the database 206) at block 604, then, at block 606, the exam locking system 102 associates a permission level with the session user. For example, the session user handler 208 may obtain permission levels from the example database 206 and associate one of the permission levels with the session user.

At block 608, the example exam locking system 102 identifies medical exams assigned and/or allocated to the session user. For example, the example database parser 210 may parse the database 206 and/or the example data center 122 (FIG. 1) to identify assigned and/or allocated medical exams. For example, the database parser 210 may check the distribution status (e.g., assigned, allocated or backlogged) of medical exams and identify which exams are assigned and/or allocated. The example database parser 210 may then identify which of the assigned and/or allocated medical exams are associated with the session user. For example, the database parser 210 may compare the session user identifier with the practitioner associated with the identified medical exams and filter the identified medical exams accordingly.

At block 610, the example database parser 210 identifies medical exams that were locked by the session user. For example, the database parser 210 may filter the identified medical exams based on the status of the lock flag associated with the medical exam (e.g., set or reset). At block 612, the exam locking system 102 populates the user interface 134 with the workflow queue for the session user. For example, the database parser 210 may cause the example output handler 202 (FIG. 2) to display locked medical exams while not displaying unlocked medical exams. In this manner, the example exam locking system 102 provides the locked medical exams to the healthcare practitioner regardless of when or where the practitioner accesses the example healthcare system 100. For example, if a healthcare practitioner locks a medical exam at a first institution and then accesses the healthcare system at a second institution in a cross-review network of healthcare institutions, the locked medical exam is displayed and made available to the healthcare practitioner at the second institution.

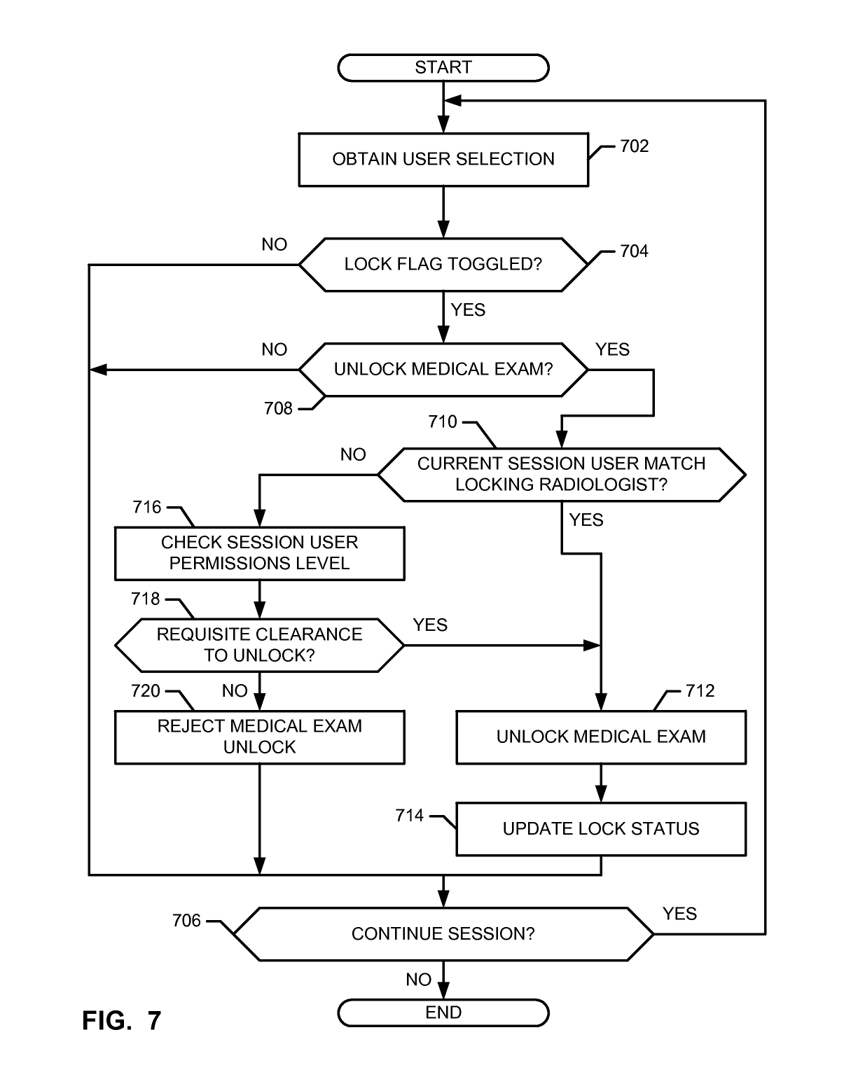

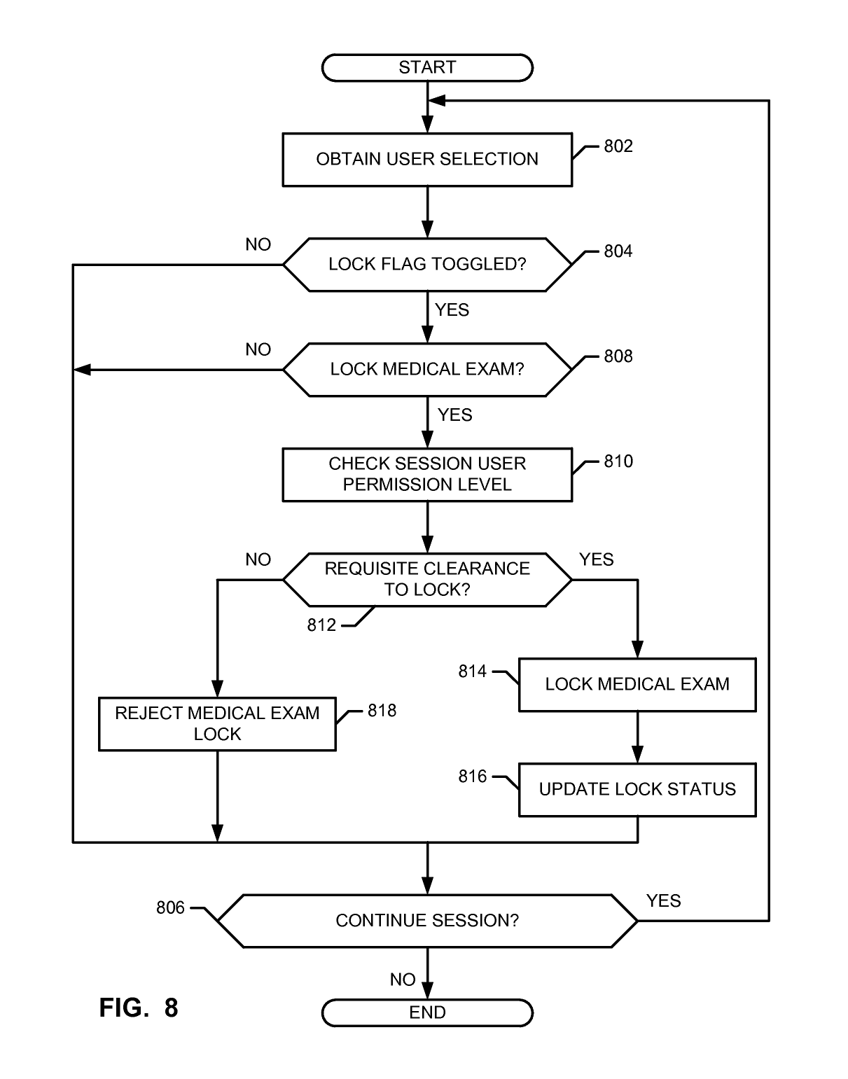

At block 614, the example exam locking system 102 monitors user input via interactions with the user interface 134. For example, the exam locking system 102 may monitor user selections received via the example input handler 204. In some examples, the user selections may include instructions to the exam locking system 102 to view additional information about a medical exam, lock an unlocked exam, unlock a locked exam, view additional information about a healthcare practitioner, etc. Monitoring the user input is described in further detail in conjunction with FIGS. 7 and 8.

At block 616, the example exam locking system 102 determines whether to end the current session. If, at block 616, the exam locking system 102 determines to continue the current session (e.g., the practitioner is interacting with the user interface 134), control returns to block 608 to identify medical exams associated and/or allocated to the session user. Otherwise, if, at block 616, the exam locking system 102 determines to end the current session (e.g., due to a session logout process, a workstation shutdown event, etc.), the session user handler 208 logs the session user out of the current session and the example process of FIG. 6 ends.

The example method of FIG. 7 monitors user input to determine whether to modify the lock status of a medical exam. The example method of FIG. 7 may be used to implement block 614 of FIG. 6. The example method of FIG. 7 begins at block 702 when the example exam locking system 102 (FIGS. 1 and/or 2) obtains a user selection. For example, the example input handler (FIG. 2) may receive instructions via the example user interface 134 (FIGS. 1, 3, 4 and/or 5). At block 704, the exam locking system 102 determines whether the user selection corresponds to toggling a lock flag. For example, the example flag modifier 212 (FIG. 2) may determine whether the user selection corresponds to selection of a button to toggle the lock status of the medical exam (e.g., the example lock flag control 412 (FIG. 4) or the example lock flag control 512 (FIG. 5)).

If, at block 704, the flag modifier 212 determines the user selection does not correspond to toggling a lock flag, then control proceeds to block 706, at which the exam locking system 102 determines whether to continue the current session. If, at block 706, the exam locking system 102 determines to continue the current session (e.g., the healthcare practitioner is interacting with the user interface 134), control returns to block 702 to obtain another user selection. In some examples, the exam locking system 102 may process the user selection before obtaining another user selection. For example, the exam locking system 102 may cause the output handler 202 (FIG. 2) to display a second user interface 134. Otherwise, if, at block 706, the exam locking system 102 determines to end the current session (e.g., due to a session logout process, a workstation shutdown event, etc.), the session user handler 208 logs the session user out of the current session and the example process of FIG. 7 ends.

Returning to block 704, if the exam locking system 102 determines that the user selection does correspond to toggling a lock flag, control advances to block 708, at which the flag modifier 212 determines whether the toggling action corresponds to unlocking the medical exam. If, at block 708, the flag modifier 212 determines that the toggling action does not correspond to unlocking the medical exam (e.g., the practitioner is attempting to lock the medical exam via selecting the lock flag control 412), control advances to block 706, at which the exam locking system 102 determines whether to continue the current session.

Otherwise, if, at block 708, the exam locking system 102 determines that the toggling action does correspond to unlocking the medical exam, then, at block 710, the example flag unlocker 216 (FIG. 2) determines whether the current session user matches the locking radiologist. For example, the flag unlocker 216 may check whether the session user identifier matches (e.g., is the same as) the practitioner identifier of the radiologist who locked the medical exam. If, at block 710, the flag unlocker 216 determines that the current session user matches the locking radiologist, control proceeds to block 712, at which the flag unlocker 216 unlocks the medical exam. For example, the flag unlocker 216 may clear the radiologist identifier appended to the medical exam. At block 714, the flag unlocker 216 updates the lock status of the medical exam. For example, the flag unlocker 216 may reset the lock flag associated with the medical exam in the example database 206 (FIG. 2) (e.g., toggle the lock flag to a 0, false, off, no, etc.). Control then proceeds to block 706, at which the exam locking system 102 determines whether to continue the current session.

Returning to block 710, if the flag unlocker 216 determines that the current session user does not match the locking radiologist, then, at block 716, the flag unlocker 216 checks the permission level associated with the session user. For example, the flag unlocker 216 may receive a notification from the example session user handler 208 (FIG. 2) indicative of whether the session user has the requisite clearance to unlock the medical exam. If, at block 718, the flag unlocker 216 determines that the session user does have the requisite clearance to unlock the medical exam, control proceeds to block 712, at which the flag unlocker 216 unlocks the medical exam.

Otherwise, if, at block 718, the flag unlocker 216 determines the session user does not have the requisite clearance to unlock the locked medical exam, then, at block 720, the flag unlocker 216 rejects unlocking the medical exam. For example, the flag unlocker 216 may output, via the example output handler 202, an alert to indicate that the session user did not have the proper clearance. For example, the flag unlocker 216 may cause the output handler 202 to output a sound, flash the user interface 134, display text (e.g., “You are not authorized to unlock the locked medical exam.”) in the user interface 134, etc. Control then proceeds to block 706, at which the exam locking system 102 determines whether to continue the current session.

The example method of FIG. 8 monitors user input to determine whether to modify the lock status of a medical exam. The example method of FIG. 8 may be used to implement block 614 of FIG. 6. The example method of FIG. 8 begins at block 802 when the example exam locking system 102 (FIGS. 1 and/or 2) obtains a user selection. For example, the example input handler (FIG. 2) may receive instructions via the example user interface 134 (FIGS. 1, 3, 4 and/or 5). At block 804, the exam locking system 102 determines whether the user selection corresponds to toggling a lock flag. For example, the example flag modifier 212 (FIG. 2) may determine whether the user selection corresponds to selection of a button to toggle the lock status of the medical exam (e.g., the example lock flag control 412 (FIG. 4) or the example lock flag control 512 (FIG. 5)).

If, at block 804, the flag modifier 212 determines the user selection does not correspond to toggling a lock flag, then control proceeds to block 806, at which the exam locking system 102 determines whether to continue the current session. If, at block 806, the exam locking system 102 determines to continue the current session (e.g., the practitioner is continuing to interact with the user interface 134), control returns to block 802 to obtain another user selection. In some examples, the exam locking system 102 may process the user selection before obtaining another user selection. For example, the exam locking system 102 may cause the output handler 202 (FIG. 2) to display a second user interface 134. Otherwise, if, at block 806, the exam locking system 102 determines to end the current session (e.g., due to a session logout process, a workstation shutdown event, etc.), the session user handler 208 logs the session user out of the current session and the example process of FIG. 8 ends.

Returning to block 804, if the exam locking system 212 determines that the user selection does correspond to toggling a lock flag, control advances to block 808, at which the flag modifier 212 determines whether the toggling action corresponds to locking the medical exam. If, at block 808, the flag modifier 212 determines that the toggling action does not correspond to locking the medical exam (e.g., the healthcare practitioner is attempting to unlock the medical exam), controls proceeds to block 806, at which the exam locking system 102 determines whether to continue the current session.

Otherwise, if, at block 808, the flag modifier 212 determines that the toggling action does correspond to locking the medical exam, then, at block 810, the example flag locker 214 (FIG. 2) checks the permission level associated with the session user. For example, the flag locker 214 may receive a notification from the example session user handler 208 (FIG. 2) indicative of whether the session user has the requisite clearance to unlock the medical exam. If, at block 812, the flag locker 214 determines that the session user does have the requisite clearance to lock the medical exam, control proceeds to block 814, at which the flag locker 214 locks the medical exam. For example, the flag locker 214 may append a radiologist identifier corresponding to the session user identifier to the medical exam. At block 816, the flag locker 214 updates the lock status of the medical exam. For example, the flag locker 214 may set the lock flag associated with the medical exam in the example database 206 (FIG. 2) (e.g., toggle the lock flag to a 1, true, on, yes, etc.). Control then proceeds to block 806, at which the exam locking system 102 determines whether to continue the current session.

Otherwise, if, at block 812, the flag locker 214 determines the session user does not have the requisite clearance to lock the unlocked medical exam, then, at block 818, the flag locker 214 rejects locking the medical exam. For example, the flag locker 214 may output, via the example output handler 202, an alert to indicate that the session user did not have the proper clearance. For example, the flag locker 214 may cause the output handler 202 to output a sound, flash the user interface 134, display text (e.g., “You are not authorized to lock this medical exam.”) in the user interface 134, etc. Control then proceeds to block 806, at which the exam locking system 102 determines whether to continue the current session.

FIG. 9 is a block diagram of an example processor platform 900 capable of executing the instructions of FIGS. 6-8 to implement the exam locking system of FIGS. 1 and/or 2. The processor platform 900 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 900 of the illustrated example includes a processor 912. The processor 912 of the illustrated example is hardware. For example, the processor 912 can be implemented by one or more integrated circuits, logic circuits, microprocessors or controllers from any desired family or manufacturer.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives.

The coded instructions 932 of FIGS. 6-8 may be stored in the mass storage device 928, in the volatile memory 914, in the non-volatile memory 916, and/or on a removable tangible computer readable storage medium such as a CD or DVD.

From the foregoing, it will appreciate that the above disclosed methods, apparatus and articles of manufacture allow a healthcare practitioner to lock a medical exam and prevent other practitioners from modifying the medical exam.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

Additionally or alternatively, while the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for locking a medical exam in a workflow queue for a clinical user, the method comprising:
authenticating the clinical user during a user session;
obtaining a user selection of the medical exam in the workflow queue during the user session;
associating a permission level to a session user identifier associated with the user session;
determining whether the permission level includes clearance to lock the medical exam; and
in response to determining that the permission level includes clearance to lock the medical exam, flagging the medical exam as read-only, wherein the flagged medical exam remains flagged after the clinical user ends the user session.

2. A method as defined in claim 1, further comprising:
populating a user interface with a listing of medical exams in the workflow queue, the listing of medical exams including the flagged medical exam and an unflagged medical exam, and wherein populating the user interface further comprises:
displaying a first icon associated with the flagged medical exam; and
displaying a second icon associated with the unflagged medical exam.

3. A method as defined in claim 2, wherein the flagged medical exam is a first flagged medical exam, the workflow queue is a first workflow queue for a first clinical user, the user interface is a first user interface, the listing of medical exams is a first listing of medical exams, and the method further comprising:
populating a second user interface with a second listing of medical exams in a second workflow queue for a second clinical user, the second listing of medical exams including the first listing of medical exams and a second flagged medical exam, and wherein populating the second user interface further comprises associating the first icon with the second flagged medical exam.

4. A method as defined in claim 3, wherein the user selection is a hover action, the method further comprising:
obtaining the user selection of the first flagged medical exam; and
displaying the session user identifier.

5. A method as defined in claim 4, wherein the user selection is a first user selection, the session user identifier is a first session user identifier, and the method further comprising:
obtaining a second user selection of the second flagged medical exam; and
displaying a second session user identifier associated with the second clinical user.

6. A method as defined in claim 1, wherein the medical exam is flagged in a persistent database.

7. A method as defined in claim 1, further comprising appending the session user identifier to the flagged medical exam.

8. A method as defined in claim 1, wherein the user selection further comprises toggling a lock flag to a first position.

9. A method as defined in claim 1, wherein the user session is a first user session, the method further comprising populating a user interface with the flagged medical exam during a second user session, the second user session initiated after the first user session ends.

10. A method as defined in claim 9, wherein the user selection is a first user selection, the session user identifier is a first session user identifier associated with the first user session, and the permission level is a first permission level, the method further comprising:
obtaining a second user selection during the second user session, the second user selection corresponding to unlocking the flagged medical exam;
identifying a second session user identifier associated with the second user session;
determining whether the second session user identifier matches the first session user identifier; and
in response to determining that the second session user identifier matches the first session user identifier, unflagging the flagged medical exam as read-only.

11. A method as defined in claim 10, further comprising:
in response to determining that the second session user identifier does not match the first session user identifier, associating a second permission level to the second session user identifier;
determining whether the second permission level includes clearance to unlock the flagged medical exam; and
in response to determining that the second permission level includes clearance to unlock the flagged medical exam, unflagging the flagged medical exam as read-only.

12. A method as defined in claim 10, wherein unflagging the flagged medical exam enables editing of the unflagged medical exam by another clinical user.

13. A method as defined in claim 9, wherein the first user session is initiated at a first institution and the second user session is initiated at a second institution.

14. A system to lock a medical exam in a workflow queue for a clinical user, the system comprising:
an input handler to obtain a user selection of the medical exam in the workflow queue during a user session;
a session user handler to:
authenticate the clinical user during the user session;
associate a permission level to a session user identifier associated with the user session; and
determine whether the permission level includes clearance to lock the medical exam; and
a flag locker to, in response to a determination that the permission level includes clearance to lock the medical exam, flag the medical exam as read-only, and wherein the flagged medical exam remains flagged after the clinical user ends the user session.

15. A system as defined in claim 14, further comprising:
a database parser to facilitate populating a user interface with a listing of medical exams in the workflow queue, the listing of medical exams to include the flagged medical exam and an unflagged medical exam; and
an output handler to display on the user interface a first icon associated with the flagged medical exam, and the output handler to display on the user interface a second icon associated with the unflagged medical exam.

16. A system as defined in claim 15, wherein the flagged medical exam is a first flagged medical exam, the workflow queue is a first workflow queue for a first clinical user, the user interface is a first user interface, the listing of medical exams is a first listing of medical exams, and the system further comprising:
the database parser to facilitate populating a second user interface with a second listing of medical exams in a second workflow queue for a second clinical user, the second listing of medical exams to include the first listing of medical exams and a second flagged medical exam; and
a flag modifier to associate the first icon with the second flagged medical exam.

17. A system as defined in claim 14, wherein the flag locker is to flag the medical exam as read-only in a persistent database.

18. A machine readable storage medium comprising instructions that, when executed, cause a machine to at least:
authenticate a clinical user during a user session;
obtain a user selection of a medical exam in a workflow queue for the clinical user during the user session;
associate a permission level to a session user identifier associated with the user session;
determine whether the permission level includes clearance to lock the medical exam; and
in response to a determination that the permission level includes clearance to lock the medical exam, flag the medical exam as read-only, wherein the flagged medical exam remains flagged in a persistent database after the clinical user ends the user session.

19. A machine readable storage medium as defined in claim 18, wherein the user session is a first user session, and wherein the instructions further cause the machine to populate a user interface with the flagged medical exam during a second user session, the second user session to be initiated after the first user session ends.

20. A machine readable storage medium as defined in claim 19, wherein the user selection is a first user selection, the session user identifier is a first session user identifier associated with the first user session, and the permission level is a first permission level, and wherein the instructions further cause the machine to:
obtain a second user selection during the second user session, the second user selection to correspond to unlocking the flagged medical exam;
identify a second session user identifier associated with the second user session;
determine whether the second session user identifier matches the first session user identifier; and
in response to a determination that the second session user identifier matches the first session user identifier, unflag the flagged medical exam as read-only.

21. A machine readable storage medium as defined in claim 20, wherein unflagging the flagged medical exam enables flagging of the unflagged medical exam by another clinical user.
